(19) United States
(12) Patent Application Publication
(10) Pub. No.: US 2018/0370839 A1
(43) Pub. Date: Dec. 27, 2018

(54) METHOD AND SYSTEM FOR MAKING ARTICLES FROM PREFORMED MATERIALS

(71) Applicant: CORNING INCORPORATED, CORNING, NY (US)

(72) Inventors: Jean-Luc Dabouineau, Nemours (FR); Elias Panides, Horseheads, NY (US); William Robert Powell, Horseheads, NY (US); Irene Marjorie Slater, Lindley, NY (US); Sam Samer Zoubi, Horseheads, NY (US)

(21) Appl. No.: 15/778,819

(22) PCT Filed: Nov. 29, 2016
(86) PCT No.: PCT/US16/63902

§ 371 Date: May 24, 2018

Related U.S. Application Data
(60) Provisional application No. 62/260,867, filed on Nov. 30, 2015.

(51) Int. Cl. C03B 23/025; C03B 23/023; C03B 23/035; C03B 23/03; C03B 40/04

(52) U.S. Cl. CPC C03B 23/0258; C03B 23/0235; C03B 40/04; C03B 23/0305; C03B 23/0307; C03B 23/0355

(57) ABSTRACT

A method of making articles from preformed materials includes placing a preformed material on a mold such that a non-quality region of the preformed material contacts the mold and a quality region of the preformed material is free of contact with the mold. A non-contact support is provided to the quality region to control sagging of the quality region. A reformable area of the preformed material is formed into a select shape by contacting the reformable area with a forming tool while restricting contact between the forming tool and the reformable area to the non-quality region. After the forming of the reformable area, an article is extracted from the quality region.

### CROSS-REFERENCE TO RELATED APPLICATIONS

This application claims the benefit of priority under 35 U.S.C. § 119 of U.S. Provisional Application Ser. No. 62/260,867 filed on Nov. 30, 2015, the content of which is relied upon and incorporated herein by reference in its entirety.

### BACKGROUND

Glass covers for portable electronic devices, such as smart phones and tablets, typically have a combination of a central flat area for covering a display of the device and an edge area for fitting the glass cover to the device. The edge area may be flat or may include any combination of bends, corners, and curves for wrapping around an object, such as around the edge of the display. Glass covers may be formed from a glass preform by thermal reforming. Traditional thermal reforming processes for glass preforms typically include some combination of sagging, pressing, pulling vacuum, and applying pressure to shape the preform. These shaping methods involve conforming the glass preform to one or two mold surfaces, which creates conditions for inducing cosmetic defects on the surface of the formed article. Secondary finishing operations such as glass grinding, polishing, and etching are typically needed to remove cosmetic defects, leading to an increase in manufacturing costs.

### SUMMARY

In a first aspect, a method of making articles from preformed materials includes placing a preformed material on a mold. The performed material has at least one quality region and at least one non-quality region adjoining the at least one non-quality region. The placement of the preformed material on the mold is such that the at least one non-quality region contacts the mold and the at least one quality region is free of contact with the mold. The method includes providing a non-contact support to the at least one quality region to control sagging of the at least one quality region. The method further includes forming a reformable area of the preformed material into a select shape by contacting the reformable area with at least one forming tool, wherein at least a portion of the reformable area is located in the at least one non-quality region, and wherein contact between the at least one forming tool and the reformable area occurs only in the at least one non-quality region. The method further includes extracting an article from the at least one quality region.

In a second aspect, the method is as described in the first aspect, and the method further includes selectively heating the preformed material such that a temperature of the reformable area is between a strain point and a softening point of the preformed material while applying the forming force.

In a third aspect, the method is as described in the first or second aspect, and providing the non-contact support includes configuring the non-contact support to minimize sagging of the at least one quality region.

In a fourth aspect, the method is as described in any one of the first to the third aspects, a temperature of the reformable area during forming the reformable area is between a strain point and a softening point of the preformed material, and the method further includes selectively heating or cooling the preformed material such that a portion of the at least one quality region outside of the reformable area is relatively colder than the reformable area.

In a fifth aspect, the method is as described in any one of the first to the fourth aspects, and providing the non-contact support includes applying a pneumatic pressure, pressure differential, or levitation force to at least one surface of the at least one quality region.

In a sixth aspect, the method is as described in the fifth aspect, and applying the pneumatic pressure includes placing at least one air bearing in opposing relation to the at least one surface of the at least one quality region.

In a seventh aspect, the method is as described in the fifth aspect, and applying the pneumatic pressure or pressure differential includes sandwiching the at least one quality region between a set of opposed air bearing.

In an eighth aspect, the method is as described in any one of the first to the seventh aspects, and forming the reformable area includes displacing the at least one forming tool while maintaining contact between the at least one forming tool and the reformable area.

In a ninth aspect, the method is as described in the eighth aspect, and the forming tool is selected from a pressing tool, a push tool, a roller tool, and a rotating tool.

In a tenth aspect, the method is as described in any one of the first to the ninth aspects, and the method further includes applying tension to the reformable area prior to or during forming the reformable area.

In an eleventh aspect, the method is as described in any one of the first to the tenth aspects, and the reformable area is located partly in the at least one quality region and partly in the at least one non-quality region.

In a twelfth aspect, the method is as described in any one of the first to the eleventh aspects, and the preformed material is made of glass or glass-ceramic.

In a thirteenth aspect, the method is as described in any one of the first to the twelfth aspects, and the preformed material is in the form of a sheet or ribbon.

In a fourteenth aspect, the method is as described in any one of the first to the thirteenth aspects, and the article is free of cosmetic defects.

In a fifteenth aspect, a system for making articles from preformed materials includes a mold having at least one supporting structure and at least one cavity adjacent to the supporting structure, the at least one supporting structure for contact placement of a non-quality region of a preformed material and the at least one cavity for non-contact placement of a quality region of the preformed material. The system further includes a non-contact support arrangement aligned with the at least one cavity and operable to apply a non-contact support force to the at least one quality region of the preformed material when the preformed material is placed on the mold. The system further includes at least one forming tool movable relative to the mold and operable to apply a forming force to the at least one non-quality region of the preformed material when the preformed material is placed on the mold.

In a sixteenth aspect, the system is as described in the fifteenth aspect, and the non-contact arrangement includes at least one air bearing disposed in the at least one cavity.

In a seventeenth aspect, the system is as described in the fifteenth aspect, and the non-contact support arrangement includes at least two air bearings, one arranged within the at least one cavity and the other in opposing relation to the one arranged within the at least one cavity such that the quality region of the preformed material is sandwiched between the at least two air bearings when the preformed material is placed on the mold.

In an eighteenth aspect, the system is as described in the fifteenth aspect, and the non-contact support arrangement includes a levitation device.

In a nineteenth aspect, the system is as described in any of the fifteenth to the eighteenth aspects, and the forming tool is selected from a pressing tool, a push tool, a roller tool, and a rotating tool.

It is to be understood that both the foregoing general description and the following detailed description are exemplary of the invention and are intended to provide an overview or framework for understanding the nature and character of the invention as it is claimed. The accompanying drawings are included to provide a further understanding of the invention and are incorporated in and constitute a part of this specification. The drawings illustrate various embodiments of the invention and together with the description serve to explain the principles and operation of the invention.

### BRIEF DESCRIPTION OF THE DRAWINGS

The following is a description of the figures in the accompanying drawings. The figures are not necessarily to scale, and certain features and certain views of the figures may be shown exaggerated in scale or in schematic in the interest of clarity and conciseness.

FIGS. 1A-1D show examples of preformed material configurations.

FIG. 2A shows an exemplary frame mold.

FIG. 2B shows a preformed material placed on the frame mold of FIG. 2A.

FIG. 2C shows the preformed material of FIG. 2B secured to the frame mold of FIG. 2B using weights.

FIG. 2D shows a frame mold supporting a preformed material with two quality regions.

FIG. 2E shows a quality region of the preformed material of FIGS. 2B and 2C sandwiched between opposed air bearings.

FIG. 2F shows reformable areas of the preformed material as supported in FIG. 2B.

FIG. 3A shows exemplary push tools applying forces to reformable areas of the preformed material of FIG. 2B.

FIG. 3B shows bending of a reformable area of the preformed material of FIG. 3A.

FIG. 3C shows tension being applied to a reformable area of the preformed material of FIG. 3A.

FIG. 3D shows the preformed material of FIG. 3B after reforming.

FIG. 3E shows an article extracted from the preformed material of FIG. 3D.

FIG. 4A shows exemplary pressing tools applying forces to reformable areas of the preformed material of FIG. 2B.

FIG. 4B is a top view of the setup of FIG. 4A with some parts removed to allow viewing of the preformed material.

FIG. 5 shows an exemplary rotating tool for shaping a reformable area of a preformed material.

FIG. 6 shows an exemplary roller tool for shaping a reformable area of a preformed material.

### DETAILED DESCRIPTION

A method of making an article from a preformed material includes restricting mechanical contact between the preformed material and physical objects, such as forming tools and handling tools, to a non-quality region of the preformed material. An article can be extracted from the quality region of the preformed material after the preformed material has been reformed. Since the quality region of the preformed material is not subject to mechanical contact during reforming of the preformed material, the article extracted from the quality region of the preformed material will be free of cosmetic defects normally attributed to mechanical contact. The step of extracting the article from the quality region of the preformed material is expected to be far less costly and much faster than secondary finishing operations to remove cosmetic defects. The same method can be used to make several articles from a preformed material having several quality regions.

A “preformed material,” as used herein, may be in the form of a sheet or continuous ribbon of material. The preformed material may be flat, corrugated, or patterned. The method according to this disclosure may be used with preformed materials made of glass or glass-ceramic. The method may also be adapted for other types of materials, such as plastics, metals, and high-temperature ceramics.

The term “quality region,” as used with a preformed material, means an area of the preformed material where cosmetic defects are unacceptable or that is free of cosmetic defects. In one or more embodiments, mechanical contact with the quality region, such as contact with forming tools, is prohibited during reforming of the preformed material. The term “non-quality region,” as used with a preformed material, means an area of the preformed material where cosmetic defects are allowable or that may not be free of cosmetic defects. Mechanical contact with the non-quality region is permitted during reforming of the preformed material. A preformed material may have one or more quality regions and one or more non-quality regions. Each quality region will share a common border with at least one non-quality region such that the shape of the quality region near the common border can be influenced by shaping of the at least one non-quality region.

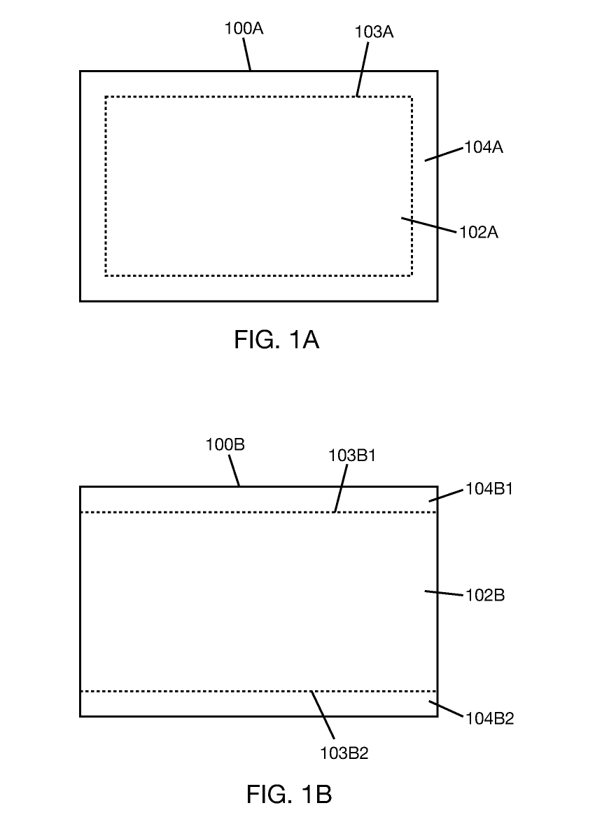

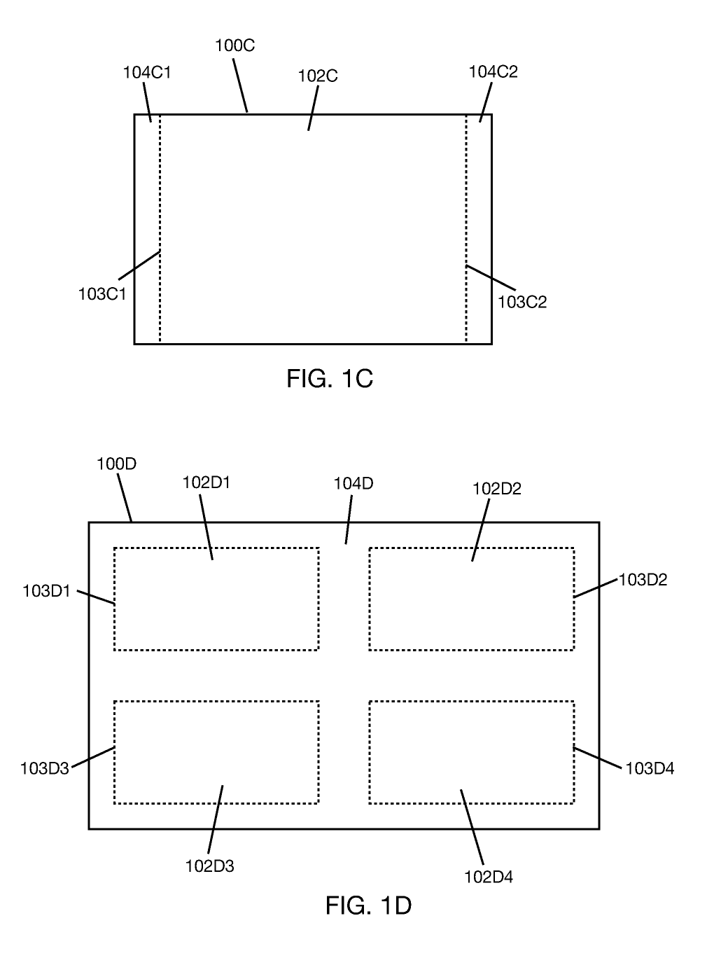

For illustrative purposes, examples of preformed material configurations are shown in FIGS. 1A-1D. In the example of FIG. 1A, the preformed material 100A has a quality region 102A and a non-quality region 104A circumscribing and adjoining a periphery 103A of the quality region 102A. In the example of FIG. 1B, the preformed material 100B has a quality region 102B and non-quality regions 104B1, 104B2 adjoining opposite long sides 103B1, 103B2, respectively, of the quality region 102B. In the example of FIG. 1C, the preformed material 100C has a quality region 102C and non-quality regions 104C1, 104C2 adjoining opposite short sides 103C1, 103C2, respectively, of the quality region 102C. In the example of FIG. 1D, the preformed material 100D has a plurality of quality regions 102D1, 102D2, 102D3, 102D4 and a non-quality region 104D circumscribing and adjoining each of the peripheries 103D1, 103D2, 103D3, 103D4 of the quality regions 102D1, 102D2, 102D3, 102D4. Other preformed material configurations besides those shown in FIGS. 1A-1D are possible.

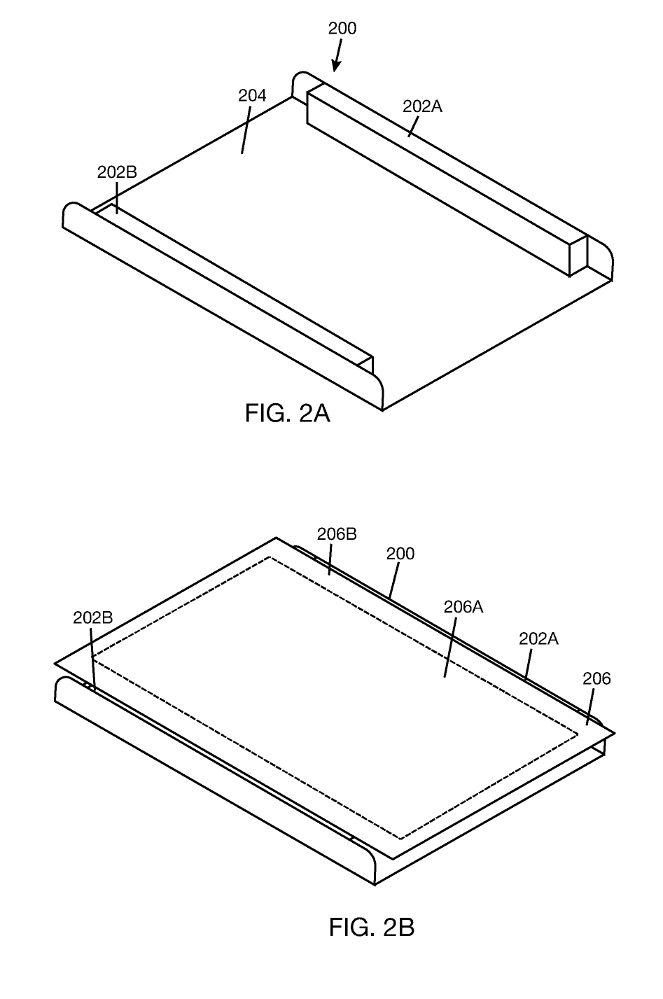

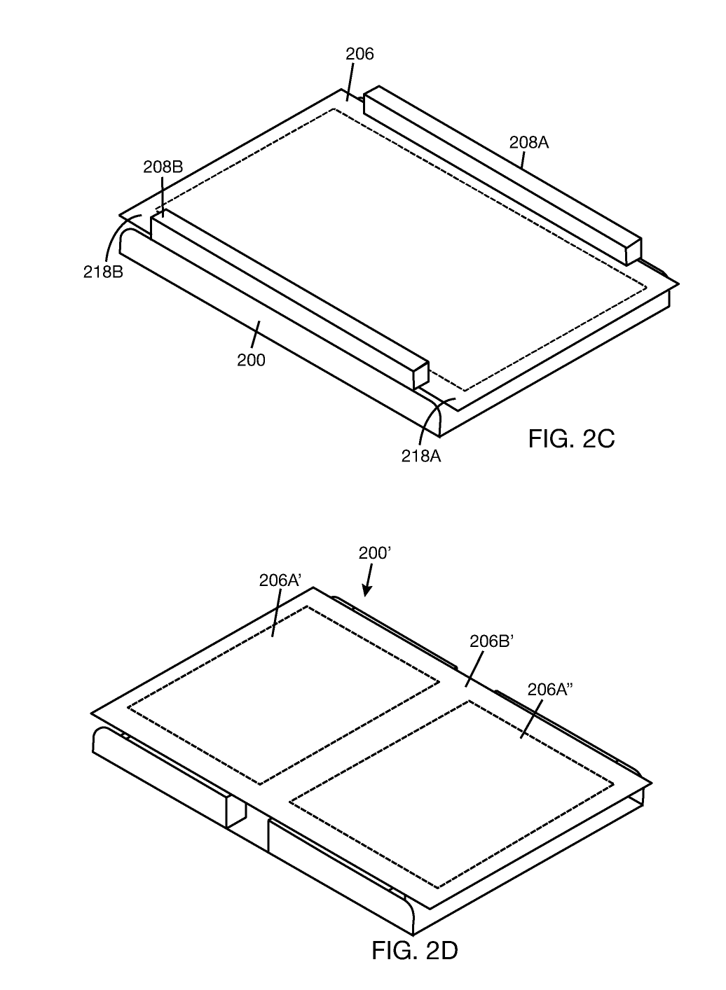

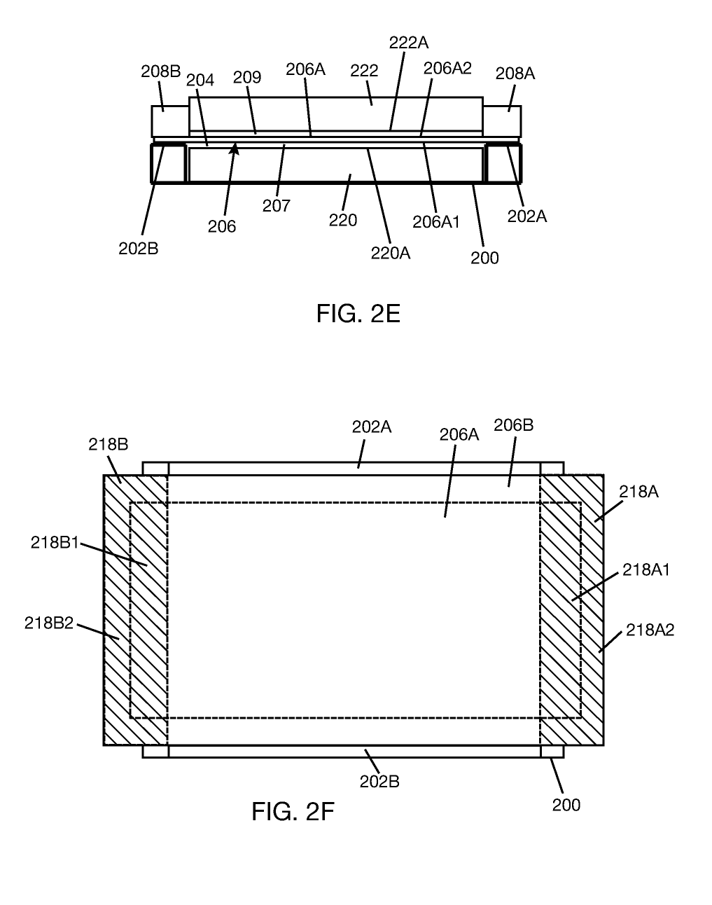

FIG. 2A shows an exemplary frame mold 200 that may be used to support a preformed material during reforming of the preformed material. The frame mold 200 has two parallel support arms 202A, 202B and a cavity 204 between the support arms 202A, 202B. FIG. 2B shows an example preformed material 206 mounted on the frame mold 200. The example preformed material 206 has a quality region 206A that is circumscribed and adjoined by a non-quality region 206B. The example preformed material 206 contacts the frame mold 200 only in the non-quality region 206B, i.e., through placement of the non-quality region 206B on the support arms 202A, 202B. The quality region 206A of the preformed material 206 does not make any contact with the frame mold 200 and overlies the cavity 204. FIG. 2C shows the preformed material 206 held in place by placing weights 208A, 208B on the portions of the non-quality region 206B mounted on the support arms 202A, 202B. Other suitable devices or mechanisms, such as clamps and the like, may be used in lieu of the weights 208A, 208B to hold the preformed material 206 in place on the frame mold 200. For example, if the frame mold 200 is used in a vertical or inclined orientation, clamps may be more suitable for holding the preformed material 206 in place on the frame mold 200.

As can be appreciated, the preformed material 206 may have a different configuration than shown in FIG. 2A, such as more than one quality region and/or more than one non-quality region on a sheet or continuous ribbon. The frame mold 200 can be designed with any number and arrangement of support arms and cavities to support any desired preformed material configuration without mechanical contact with the quality region(s) of the preformed material. For example, FIG. 2D shows a frame mold 200′ configured to support a preformed material 206′ having two quality regions 206A′ and 206A″ and a non-quality region 206B′ adjoining and circumscribing the quality regions 206A′, 206A″.

In one embodiment, non-contact support is provided to the quality region 206A of the preformed material 206 to control sagging of the quality region 206A at temperatures encountered during reforming of the preformed material 206. FIG. 2E shows an example where an air bearing 220 is arranged in the cavity 204 of the frame mold 200 such that there is a gap 207 between a surface 220A of the air bearing 220 and a surface 206A1 of the non-quality region 206A facing the cavity 204. The air bearing 220 can be operated to provide a thin film of pressurized air in the gap 207. The pressurized film in the gap 207 will form a load-bearing interface between the surfaces 206A1 and 220A and can be used to minimize or prevent sagging of the quality region 206A or to control sagging of the quality region 206A such that the quality region 206A assumes a desired shape. For example, it may be desired that the quality region 206A is slightly convex.

In one embodiment, another air bearing 222 may be arranged in opposing relation to the other surface 206A2 of the quality region 206A with a gap 209 between a surface 222A of the air bearing 222 and the surface 206A2 of the quality region 206A. In this arrangement, the air bearing 222 will be in opposing relation to the air bearing 220, and the quality region 206A will be sandwiched between the opposed air bearings 220, 222. Both air bearings 220, 222 can be operated to apply a pressure differential to the quality region that will support or stabilize the quality region 206A in a desired plane, which may be a flat plane or curved plane, depending on the desired shape of the quality region 206A in the area sandwiched between the air bearings 220, 222.

In one embodiment, the preformed material 206 is flat prior to reforming, and either the air bearing 220 or both of the air bearings 220, 222 are operated to maintain the flatness of a central area of the quality region 206A during reforming of the preformed material 206. However, it has been found that at relatively high temperatures, such as encountered during reforming of the preformed material 206, applying pneumatic pressure to both sides 206A1, 206A2 of the quality region 206A using the opposed air bearings 220, 222 is more effective in maintaining the flatness of the quality region 206 compared to applying pneumatic pressure to only one side 206A1 of the quality region 206A using the air bearing 220.

In one embodiment, at least the air bearing 222 is retractable from the frame mold 200 to allow loading of the preformed material 206 on the frame mold 200. An actuator may be coupled to the air bearing 222 and used to move the air bearing 222 in and out of position above the frame mold 200. Multiple air bearings can be used when reforming a preformed material with multiple quality regions. That is, each quality region may have a corresponding set of air bearings. In another embodiment, the air bearings 220, 222 may be replaced with other devices that can provide non-contact support to the quality region 206A, such as levitation devices. In one example, acoustic near-field levitation devices can be arranged relative to the quality region 206A in the same way that the air bearings are arranged. The acoustic near-field levitation devices will create standing waves on the sides 206A1, 206A2 of the quality region 206 that can be used to stabilize the quality region 206 in a desired plane. (U.S. Pat. No. 8,354,616 to Nishimoto, for example, discloses acoustic near-field levitation devices with heating features that may be useful herein. The devices may be used with or without the heating features.) Other types of levitation devices, such as electrical or magnetic levitation devices, may be used in lieu of acoustic near-field levitation devices.

Returning to FIG. 2C, areas 218A, 218B of the preformed material 206 overhanging the support arms 202A, 202B (see FIG. 2A) and not supported by the air bearings 220, 222 are reformable areas of the preformed material 206. In one embodiment, as illustrated in FIG. 2F, the reformable area 218A has a quality reformable part 218A1 lying in the quality region 206A and a non-quality reformable part 218A2 lying in the non-quality region 206B. Similarly, the reformable area 218B has a quality reformable part 218B1 lying in the quality region 206A and a non-quality reformable part 218B2 lying in the non-quality region 206B. Force can be applied to the non-quality reformable parts 218A2, 218B2 to influence the shape of the adjoining quality reformable parts 218A1, 218B1. The shape of the quality reformable parts 218A1, 218B1 can be incorporated into an article extracted from the quality region 206A of the preformed material. Traditional forming methods, such as sagging, pressing, pulling vacuum, and applying pressure, may also be applied to the non-quality reformable parts 218A2, 218B2 to influence the shape of the adjoining quality reformable parts 218A1, 218B1.

In one embodiment, while the preformed material 206 is on the frame mold 200, the reformable areas 218A, 218B may be formed into desired shapes by contacting the reformable areas 218A, 218B with one or more forming tools. To avoid introducing cosmetic defects into the quality region 206A of the preformed material 206, forming tools are allowed to contact the preformed material 206 only in the non-quality region 206B, or more specifically in the non-quality reformable parts 218A2, 218B2. In one embodiment, the forming tools may be any of various tools for imparting a shape to a surface, such as push tools, pressing tools, rollers, and the like. Forming may also include conforming the non-quality region 206B to a mold surface or mold surfaces using traditional forming techniques such as sagging, pressing, applying vacuum, and pulling pressure.

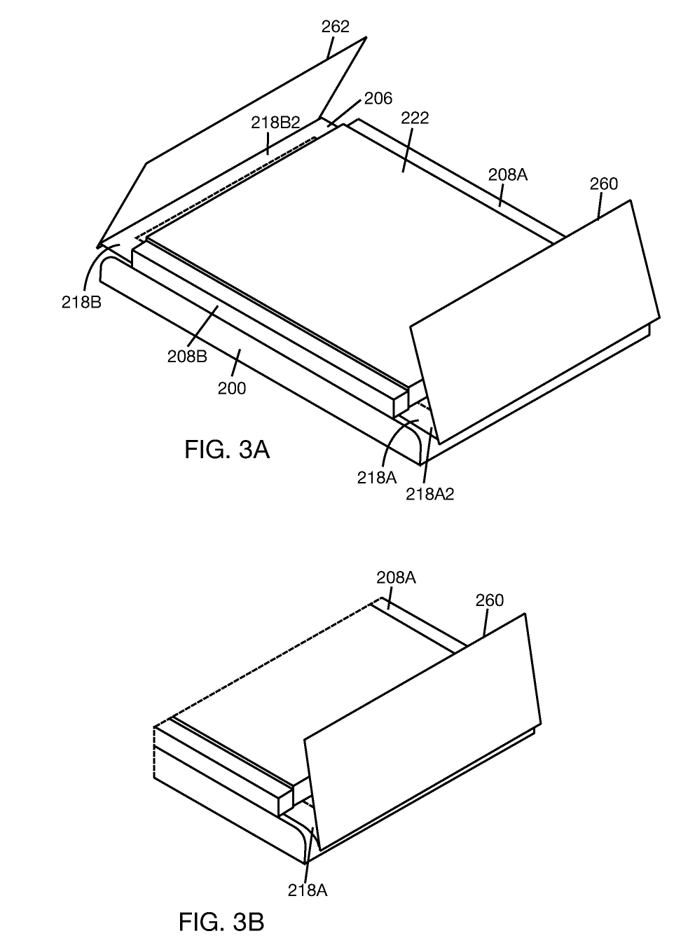

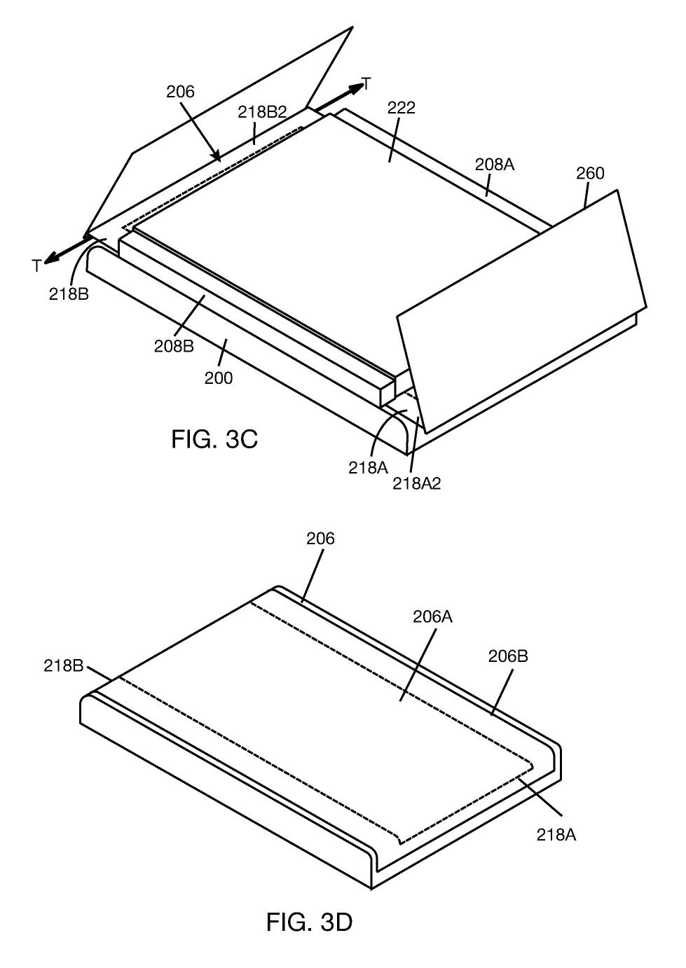

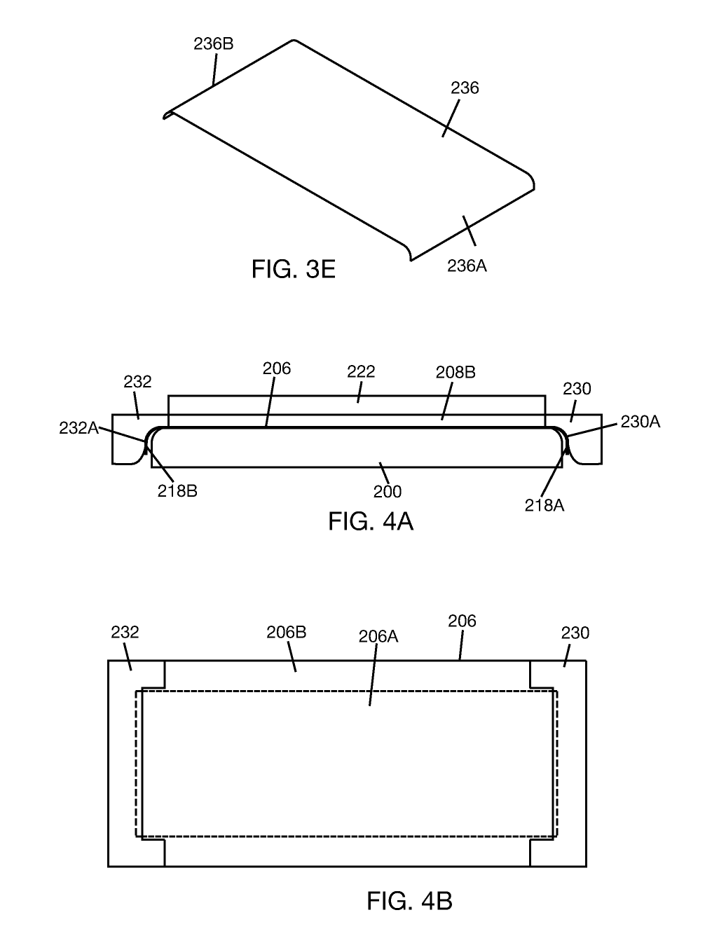

For illustration purposes, FIG. 3A shows push tools 260, 262 in contact with the outer edges of the non-quality reformable parts 218A2, 218B2. While maintaining contact between the push tools 260, 262 and the outer edges of the non-quality reformable parts 218A2, 218B2, the push tools 260, 262 are displaced in a direction to apply push forces to the non-quality reformable parts 218A2, 218B2, creating bends in the reformable areas 218A, 218B. FIG. 3B shows a bend being formed in the reformable area 218A by the push tool 260. Returning to FIG. 3A, the angles between the push tools 260, 262 and the outer edges of the non-quality reformable parts 218A2, 218B2 and the amount of push force applied to the outer edges of the non-quality reformable parts 218A2, 218B2 can be adjusted during displacement of the push tools 260, 262 to form desired bend profiles in the reformable areas 218A, 218B. The angular adjustment of the push tools 260, 262 may also be used to avoid contact between the push tools 260, 262 and the quality portions of the reformable areas 218A, 218B.

In one embodiment, the temperatures of the reformable areas 218A, 218B are between the strain point and softening point of the preformed material 206 while shaping the reformable areas 218A, 218B using push forces or other type of forming method. This may involve preheating the preformed material 206 prior to placing the preformed material 206 on the frame mold 200 and/or applying heat to the preformed material 206 while the preformed material 206 is on the frame mold 200. In some cases, localized heat may be applied to the reformable areas 218A, 218B while allowing the remainder of the preformed material 206, such as the central area of the quality region (206A in FIG. 2F), to be relatively cold. A relatively cold quality region may reduce the requirements for non-contact support of the quality region. Other methods besides localized heating of the reformable areas 218A, 218B may be used to keep the quality region relatively cold compared to the reformable areas 218A, 218B. For example, any of the air bearings 220, 222 may be operated to apply cold air to the quality region, thereby cooling the quality region, or a portion of the quality region outside of the reformable areas 218A, 218B, to a temperature below that of the reformable areas 218A, 218B. The select portion of the quality region may cooled to a temperature at which it is less susceptible to forming.

In one embodiment, the air bearings 220, 222 (see FIG. 2E), or other non-contact devices, are operated to control sagging of the quality region 206A (see 206A in FIG. 2E) while shaping the reformable areas 218A, 218B using push forces or other type of forming method. This control may include keeping a desired area, e.g., central area, of the quality region 206A flat by minimizing sagging or allowing a desired area of the quality region to assume a predetermined shape profile by allowing controlled sagging.

Prior to forming the reformable areas 218A, 218B into desired shapes or while forming the reformable areas into desired shapes, tension (in-plane force) can be applied to the reformable areas 218A, 218B. For illustration purposes, FIG. 3C shows tension T being applied to the reformable area 218B. The tension will cause some stretching and thinning in the reformable area 218B. The tension may help in maintaining a uniform shape throughout the width of the quality region (206A in FIG. 2B) when the reformable area 218B is formed into the desired shape. Any suitable tensioning devices may be used to apply tension to the reformable areas 218A, 218B. Any contact between the tensioning devices and the preformed material 206 may be restricted to the reformable areas 218A, 218B, and in particular to the non-quality parts of the reformable areas 218A, 218B.

FIG. 3D shows the preformed material 206 after forming bends in the reformable areas 218A, 218B. The desired article can be extracted from the quality region 206A of the preformed material 206 by any suitable technique, such as laser machining. In this case, any tool contact with the formed article during extraction of the formed article can be limited to the perimeter of the article, leaving the major surfaces of the article free of cosmetic defects. FIG. 3E shows the formed article 236 extracted from the quality region of the preformed material. As shown in FIG. 3E, the edge areas 236A, 236B of the formed article 236 include the quality parts of the bends formed in the reformable areas (218A, 218B in FIG. 3D). The formed article 236 has a typical cover shape and may be used as a cover of a portable electronic device, although the method described above is not limited to any particular shapes.

Other forming tools besides push tools may be used to shape the reformable areas. For example, FIGS. 4A and 4B show pressing tools 230, 232 with profiled surfaces 230A, 232A that may be used to contact the non-quality reformable parts (218A2, 218B2 in FIG. 3A) (generally near the corner edges of the preformed material 206 as shown in FIG. 4B) and press the non-quality reformable parts into a desired shape.

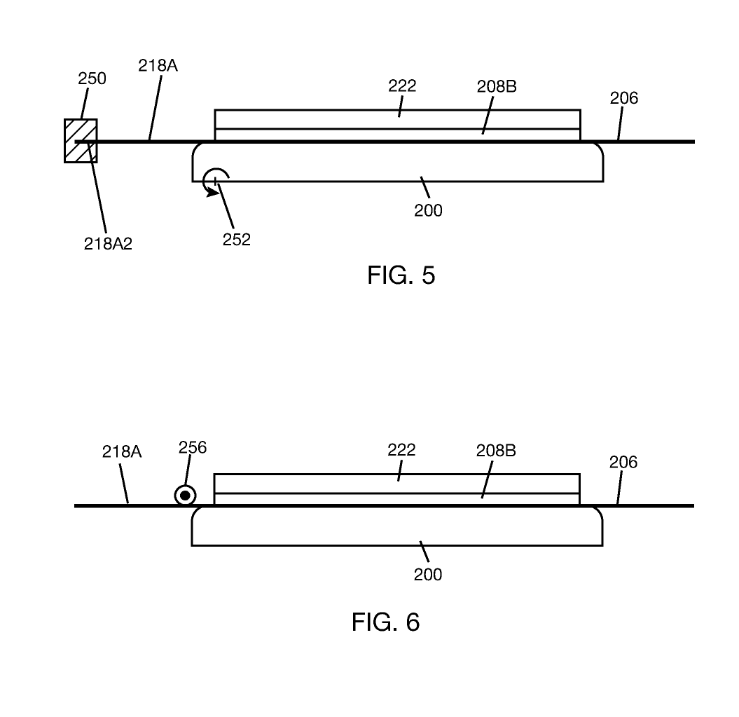

FIG. 5 shows a rotating tool 250 gripping a non-quality reformable part 218A2 of the reformable area 218A. The rotating tool 250 can be rotated about a center of rotation 252, while engaged with the non-quality reformable part 218A2, to pull the reformable area 218A into a desired shape. The center of rotation 252 may be fixed or may vary to achieve a desired shape profile.

FIG. 6 shows a roller tool 256 arranged to shape the preformed material 206 by rolling along a surface of the reformable area 218A. The weight of the roller 256 may provide the forming force, or force may be applied to the roller tool 256 as the roller tool 256 rolls along the non-quality portion of the reformable area 218A. The roller tool 256 may be controlled to follow a predetermined track as it rolls along the non-quality portion of the reformable area 218A. The roller tool 256 may extend across the entire width of the reformable area 218A. Alternatively, multiple roller tools may be used in localized regions of the reformable area, where each roller tool may be tailored to provide the corresponding localized region of the reformable area with a predetermined shape profile.

The method described above allows a multitude of forming techniques to be used in the non-quality region of the preformed material in order to influence the shape of the quality region of the preformed material, especially in the area where the quality region adjoins the non-quality region. An article free of cosmetic defects can be extracted from the quality region of the preformed material. Multiple articles can be made with a single preformed material by providing multiple quality regions in the preformed material. The method eliminates secondary finishing operations to remove cosmetic defects by keeping the quality region of the preformed material free of cosmetic defects during reforming of the preformed material.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A method of making articles from preformed materials, comprising:
placing a preformed material on a mold, wherein the preformed material has at least one quality region and at least one non-quality region adjoining the at least one quality region, the placing being such that the at least one non-quality region contacts the mold, the at least one quality region is free of contact with the mold;
providing a non-contact support to the at least one quality region to control sagging of the at least one quality region;
forming a reformable area of the preformed material into a select shape by contacting the reformable area with at least one forming tool, wherein at least a portion of the reformable area is located in the at least one non-quality region, and wherein contact between the at least one forming tool and the reformable area occurs only in the at least one non-quality region; and
extracting an article from the at least one quality region.

2. The method of claim 1, further comprising selectively heating the preformed material such that a temperature of the reformable area is between a strain point and a softening point of the preformed material while applying the forming force.

3. The method of claim 2, wherein providing the non-contact support comprises configuring the non-contact support to minimize sagging of the at least one quality region.

4. The method of claim 1, wherein a temperature of the reformable area during forming the reformable area is between a strain point and a softening point of the preformed material, and further comprising selectively heating or cooling the preformed material such that a portion of the at least one quality region outside of the reformable area is relatively colder than the reformable area.

5. The method of claim 1, wherein providing the non-contact support comprises applying a pneumatic pressure, pressure differential, or levitation force to at least one surface of the at least one quality region.

6. The method of claim 5, wherein applying the pneumatic pressure comprises placing at least one air bearing in opposing relation to the at least one surface of the at least one quality region.

7. The method of claim 5, wherein applying the pneumatic pressure or pressure differential comprises sandwiching the at least one quality region between a set of opposed air bearings.

8. The method of claim 1, wherein forming the reformable area comprises displacing the at least one forming tool while maintaining contact between the at least one forming tool and the reformable area.

9. The method of claim 8, wherein the at least one forming tool is selected from a pressing tool, a push tool, a roller tool, and a rotating tool.

10. The method of claim 1, further comprising applying tension to the reformable area prior to or during forming the reformable area.

11. The method of claim 1, wherein the reformable area is located partly in the at least one quality region and partly in the at least one non-quality region.

12. The method of claim 1, wherein the preformed material is made of glass or glass-ceramic.

13. The method of claim 1, wherein the preformed material is in the form of a sheet or ribbon.

14. The method of claim 1, wherein the article is free of cosmetic defects.

15. A system for making articles from preformed materials, comprising:
a mold having at least one supporting structure and at least one cavity adjacent to the supporting structure, the at least one supporting structure for contact placement of a non-quality region of a preformed material and the at least one cavity for non-contact placement of a quality region of the preformed material;
a non-contact support arrangement aligned with the at least one cavity and operable to apply a non-contact support force to the at least one quality region of the preformed material when the preformed material is placed on the mold; and
at least one forming tool movable relative to the mold and operable to apply a forming force to the at least one non-quality region of the preformed material when the preformed material is placed on the mold.

16. The system of claim 15, wherein the non-contact support arrangement comprises at least one air bearing disposed in the at least one cavity.

17. The system of claim 15, wherein the non-contact support arrangement comprises at least two air bearings, one arranged within the at least one cavity and the other in opposing relation to the one arranged within the at least one cavity such that the quality region of the preformed material is sandwiched between the at least two air bearings when the preformed material is placed on the mold.

18. The system of claim 15, wherein the non-contact support arrangement comprises a levitation device.

19. The system of claim 15, wherein the at least one forming tool is selected from a pressing tool, a push tool, a roller tool, and a rotating tool.
